(19) United States
(12) Patent Application Publication
(10) Pub. No.: US 2008/0057299 A1
(43) Pub. Date: Mar. 6, 2008

(54) Laminate for wiring board

(75) Inventors: Yasuhiro Adachi, Kisarazu-shi (JP); Hironori Nagaoka, Kisarazu-shi (JP); Hongyuan Wang, Kisarazu-shi (JP); Naoko Osawa, Kisarazu-shi (JP); Masahiko Takeuchi, Kisarazu-shi (JP); Hironobu Kawasato, Kisarazu-shi (JP)

Correspondence Address: EDWARDS ANGELL PALMER & DODGE LLP, P.O. BOX 55874, BOSTON, MA, 02205, US

(73) Assignee: Nippon Steel Chemical Co., Ltd., Tokyo (JP)

(21) Appl. No.: 11/891,630

(22) Filed: Aug. 10, 2007

(30) Foreign Application Priority Data
Aug. 10, 2006 (JP) 2006-218243
Aug. 10, 2006 (JP) 2006-218244
Mar. 12, 2007 (JP) 2007-061723
May 21, 2007 (JP) 2007-134022

(51) Int. Cl. B32B 15/08; B32B 27/06

(52) U.S. Cl. 428/335; 428/458

(57) ABSTRACT

The present invention aims to provide a polyimide resin excellent in heat resistance, dimensional stability, and toughness as an insulating layer, and to obtain a laminate suitable for a flexible wiring board by using the polyimide resin, the laminate being excellent in resistance to rupture and flexibility even when the thickness of a polyimide resin layer is small. Provided is a laminate for a wiring board having a metal layer on at least one surface of a polyimide resin layer, in which a polyimide resin layer (A) obtained by imidating a polyimide precursor resin having a weight average molecular weight of 150,000 to 800,000 is a main polyimide resin layer, and a polyimide resin of which the main polyimide resin layer is constituted has structural units represented by the following general formulae (1) and (2) where R represents a lower alkyl group, a phenyl group, or a halogen atom, and Ar₁ represents a residue of bis(aminophenoxy)benzene or bis(aminophenoxy)naphthalene.

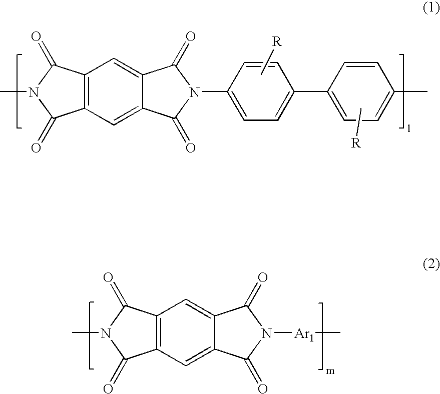

### FIELD OF THE INVENTION

The present invention relates to a laminate for a wiring board for use in a flexible wiring board or hard disk drive (HDD) suspension composed of a metal layer and an insulating layer, and using a polyimide resin in the insulating layer.

### DESCRIPTION OF THE RELATED ART

A polyimide resin excellent in various characteristics such as heat resistance, dimensional stability, and electrical characteristics has been widely used in the insulating layer of a flexible copper-clad laminate of which a flexible wiring board to be generally used in an electronic instrument is formed.

In addition, various flexible copper-clad laminate seach using polyimide in its insulating layer have been heretofore investigated. For example, JP 63-245988A discloses a flexible copper-clad laminate composed of a polyimide resin having a specific resin structure. Although a conventional polyimide resin is superior to any other organic polymer in heat resistance and electrical insulating property, the polyimide resin has a large moisture absorptivity, so the polyimide resin involves, for example, the following concerns: the swelling of a flexible wiring board obtained by processing the polyimide resin occurring upon immersion of the flexible wiring board in a soldering bath and the connection failure of an electronic instrument due to the dimensional change of the polyimide resin after moisture absorption.

In view of the foregoing, WO 01/028767 describes a laminate having a layer of a polyimide resin obtained by using a diamine containing 20 mol % or more of 4,4′-diamino-2,2′-dimethylbiphenyl as a polyimide resin of which a polyimide resin layer is formed in order that the dimensional stability of a polyimide resin against a moisture environment change may be improved.

In recent years, there have been rapid improvements in performance and functionality of an electronic instrument. In association with the improvements, there have been growing demands for the additionally high performance of electronic parts to be used in the electronic instrument or of a substrate on which the electronic parts are implemented and for an additionally high density at which the electronic parts are implemented on the substrate. In addition, the electronic instrument tends to be lighter and lighter, smaller and smaller, and thinner and thinner, so a space for storing the electronic parts never ceases to narrow. A technology for implementing a semiconductor chip on a flexible wiring board has been attracting attention as one technology for solving those problems. A flexible wiring board for use in the so-called chip on film (COF) application has a sprocket hole so as to be conveyed during its production process. However, the insulating layer of a conventional flexible wiring board has required a certain thickness of about 40 μm or more for maintaining its reliability because of the following problem: the sprocket hole is apt to rupture and deform.

On the other hand, there has also been a demand for an increase in density of wiring in a flexible wiring board for use in a movable part of, for example, a folding mobile phone or a slidable mobile phone, and high flexing resistance has been requested of the flexible wiring board in association with the demand. However, when the number of layers of a conventional flexible wiring board is increased, or the bending radius of the flexible wiring board is reduced, a problem, that is, the breakage of the flexible wiring board after the long-term use of the flexible wiring board occurs, so a flexible wiring board having flexing resistance sufficient for use in a movable part of a folding mobile phone or a slidable mobile phone has not been necessarily obtained. In view of the foregoing, the development of a copper-clad laminate capable of providing a flexible wiring board excellent in flexing resistance while taking advantage of the excellent characteristics of a polyimide resin such as dimensional stability and heat resistance has been desired.

A resin having high dimensional stability and a low moisture absorptivity is preferably used as a polyimide resin for an insulating layer also in an HDD suspension application; the resin is preferably excellent in strength and processability as well as those characteristics. One known processing method upon application of the resin to the HDD suspension application is a wet etching method involving the use of an etchant based on an alkaline aqueous solution, and a high etching rate is preferable in order that the etching shape of a portion of the resin to be processed may be good. In view of the foregoing, the development of a laminate excellent in etching characteristic to be used in an HDD suspension has also been desired.

### SUMMARY OF THE INVENTION

### Problem to Resolve of the Invention

An object of the present invention is to-provide a laminate for a wiring board which: is used in a flexible wiring board excellent in flexing resistance while taking advantage of the excellent characteristics of polyimide such as dimensional stability typified by a coefficient of thermal expansion and heat resistance requested at the time of COF implementation; is excellent in etching characteristic; and is used in an HDD suspension.

### Means to Solve the Problems

The inventors of the present invention have made studies with a view to solving the above-mentioned problems. As a result, the inventors have found that the above-mentioned problems can be solved by adopting a specific polyimide resin as a polyimide resin of which an insulating layer is constituted. Thus, the inventors have completed the present invention.

That is, the present invention provides a laminate for a wiring board including: a polyimide resin layer composed of one or more layers; and a metal layer on at least one surface of the polyimide resin layer, in which a polyimide resin layer (A) obtained by imidating a polyimide precursor resin having a weight average molecular weight in a range of 150,000 to 800,000 is a main polyimide resin layer and a polyimide resin of which the polyimide resin layer (A) is constituted is comprised of structural units represented by the following general formulae (1), (2), and (3): 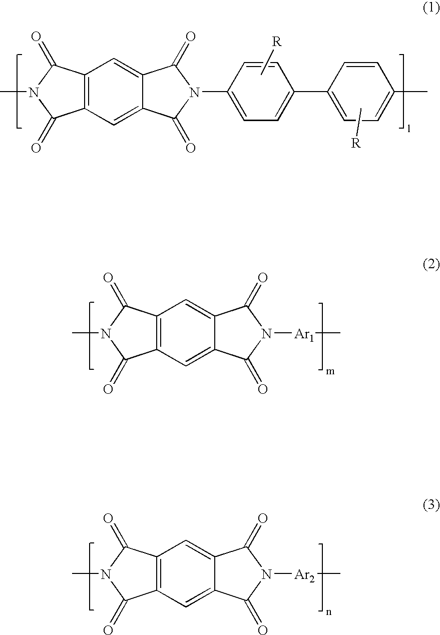
in the general formulae (1), R represents one of a lower alkyl group having 1 to 6 carbon atoms, a phenyl group, and a halogen atom, in the general formulae (2), Ar₁ represents a divalent aromatic group chosen from the following formulae (a) and (b), Ar₃ represents a divalent aromatic group chosen from the following formulae (c) and (d), in the general formulae (3), Ar₂ represents a residue of one of 3,4′-diaminodiphenylether and 4,4′-diaminodiphenylether, and 1, m, and n each represent an abundance molar ratio, and 1 represents a number in a range of 0.6 to 0.9, m represents a number in a range of 0.1 to 0.3, and n represents a number in a range of 0 to 0.2.

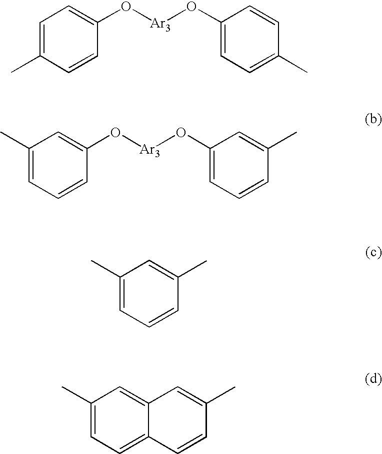

In the above general formulae (1), (2), and (3), 1 preferably represents 0.7 to 0.9, and m preferably represents 0.1 to 0.3 when n represents 0; 1 preferably represents 0.6 to 0.9, and m preferably represents 0.1 to 0.3 when n represents 0.01 to 0.2.

The polyimide resin layer (A) has preferably a thickness in a range of 5 to 30 μm, a tear propagation resistance in a range of to 100 to 400 mN, and a coefficient of thermal expansion of 30×10⁻⁶/K or less. The polyimide resin layer (A) has a glass transition temperature of 310° C. or higher, and an elastic modulus at 400° C. of 0.1 GPa or more. In addition, the laminate for a wiring board is suitable for a laminate for a flexible wiring board or an HDD suspension.

Further, the present invention provides a flexible wiring board for COF including a sprocket hole having a desired shape, the sprocket hole being provided for a side portion of the flexible wiring board obtained by subjecting the laminate for a wiring board to wiring processing.

### BRIEF DESCRIPTION OF THE DRAWINGS

FIG. 1 is a plan view of a flexible wiring board for COF.

Hereinafter, the present invention will be described in detail.

A laminate for a wiring board of the present invention has a metal layer on at least one surface, that is, one side or both sides of a polyimide resin layer. Examples of a method of laminating the polyimide resin layer and the metal layer include: the so-called casting method involving applying a polyimide precursor resin solution (also referred to as “polyamic acid solution”) and drying and curing the applied solution; the so-called laminate method involving applying thermoplastic polyimide to a polyimide film and thermally laminating a metal layer made of, for example, a copper foil or stainless steel after the application; and the so-called sputter plating method involving forming a conductive layer on the surface of a polyimide film by a sputtering treatment and forming a conductor layer by electroplating after the formation of the conductive layer. Any one of those methods may be employed; the casting method involving applying a polyimide precursor resin solution and drying and curing the applied solution is most suitable. However, the present invention is not limited to those methods.

The polyimide resin layer may be formed of a single layer, or may be formed of multiple layers; provided that the laminate must be substantially free of a resin layer except a polyimide resin layer because providing a resin layer except a polyimide resin layer such as an epoxy resin layer as an adhesive layer causes a reduction in heat resistance of the laminate. In addition, the polyimide resin layer has a polyimide resin layer (A) as a main layer. The term “main layer” as used in the present invention refers to a layer having a thickness accounting for 60% or more, or preferably 70% or more of the total thickness of the polyimide resin layer.

The polyimide resin layer (A) is constituted of structural units represented by the above general formulae (1), (2), and (3). In addition, 1, m, and n represent the abundance molar ratios of the respective structural units (the total of all structural units is represented as 1), and 1 represents a number in the range of 0.6 to 0.9, m represents a number in the range of 0.1 to 0.3, and n represents a number in the range of 0 to 0.2. It should be noted that n may represent 0, and, in this case, 1 desirably represents 0.7 to 0.9, and m desirably represents 0.1 to 0.3. When n represents 0 or more, 1 desirably represents 0.6 to 0.9, and m desirably represents 0.1 to 0.3. It is preferable that n represent 0.01 to 0.2, 1 represent 0.6 to 0.89, and m represent 0.1 to 0.3.

The structural unit represented by the general formula (1) is thought to alleviate or improve properties mainly including thermal expansibility and heat resistance; specifically, the structural unit is thought to achieve low thermal expansibility and high heat resistance. The structural unit represented by the general formula (2) is thought to improve properties mainly including toughness and adhesiveness. However, the thoughts are not strict owing to the influences of a synergistic effect between the structural units and the molecular weight of each structural unit; provided that an increase in amount of the structural unit represented by the general formula (2) is typically effective in improving, for example, toughness. The structural unit represented by the general formula (3) may adjust a balance between low thermal expansibility and toughness favorably.

In the general formula (1), R represents a lower alkyl group having 1 to 6 carbon atoms, a phenyl group, or a halogen atom. A preferable example of the structural unit represented by the general-formula (1) in the present invention is a structural unit represented by the following formula (4).

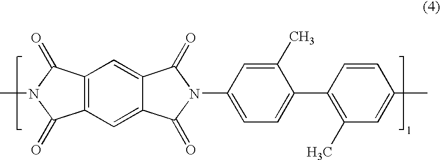

In the general formula (2), Ar₁ represents a divalent aromatic group chosen from the above formulae (a) and (b) In the formulae (a) and (b), Ar₃ represents a divalent aromatic group chosen from the above formulae (c) and (d) Preferable examples of Ar₁ include divalent aromatic groups represented by the following formulae (e) (f), and (g).

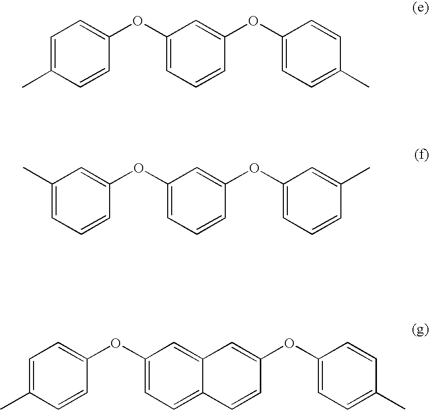

In addition, in the general formula (3), Ar₂ represents a residue (group remaining after the removal of an amino group) of 3,4′-diaminodiphenylether or 4,4′-diaminodiphenylether.

A polyimide resin of which the polyimide resin layer (A) is constituted is obtained by imidating a polyimide precursor resin having a weight average molecular weight in the range of 150,000 to800,000, or preferably 200,000 to 800,000. When the weight average molecular weight is less than 150,000, the tear propagation resistance of a film made of the polyimide resin weakens. When the weight average molecular weight exceeds 800,000, it becomes difficult to produce a uniform film from the polyimide resin. The weight average molecular weight can be determined by a GPC method to be a value in terms of polystyrene. It should be noted that the weight average molecular weight of the polyimide precursor resin can be regarded as the weight average molecular weight of the polyimide resin because the weight average molecular weight of the polyimide resin obtained by imidating the polyimide precursor resin is substantially equal to that measured in a polyimide precursor resin state.

The total thickness of the polyimide resin layer falls within the range of preferably 10 to 40 μm, or more preferably 15 to 30 μm. In addition, the thickness of the polyimide resin layer (A) falls within the range of 5 to 35 μm, preferably 5 to 30 μm, or more preferably 10 to 30 μm. Setting the thickness of the polyimide resin layer (A) in the range can provide a substrate for flexible wiring excellent in flexibility.

In addition, when the tear propagation resistance of the polyimide resin layer (A) is set to 100 to 400 mN, or advantageously 130 to 350 mN, a laminate for a flexible wiring board in which the polyimide resin layer hardly ruptures or deforms even when its thickness is reduced, and which is excellent in flexibility can be obtained. In addition, setting the coefficient of thermal expansion of the polyimide resin layer (A) to 30×10⁻⁶/K or less, or advantageously 25×10⁻⁶/K or less can control the deformation of the polyimide resin layer (A) such as curl. Further, when the polyimide resin layer (A) is provided with a glass transition temperature of 310° C. or higher, or advantageously 310 to 500° C., and an elastic modulus at 400° C. of 0.1 GPa or more, or advantageously 0.15 to 5 GPa, the polyimide resin layer (A) can be implemented a thigh temperatures, whereby a laminate for a flexible wiring board particularly suitable for a COF application can be obtained. The polyimide resin layer (A) having such characteristics can be obtained by setting the ratio of each structural unit of which the polyimide resin layer (A) is constituted, or the molecular weight of the polyimide resin of which the polyimide resin layer (A) is constituted in an optimum range.

As described above, the polyimide resin layer of the present invention can be formed of multiple layers. A polyimide resin of which each of the polyimide resin layer (A) and any other polyimide resin layer except the polyimide resin layer (A) is constituted can be produced by: polymerizing a diamine and an acid anhydride as raw materials in the presence of a solvent to prepare a polyimide precursor resin; and imidating the polyimide precursor resin by a heat treatment. Examples of the solvent include dimethylacetamide, dimethylformamide, N-methylpyrrolidinone, 2-butanone, diglyme, and xylene. One kind of the solvents may be used, or two or more kinds of them may be used in combination.

Examples of the diamine as a polyimide resin raw material of which the other polyimide resin layer is constituted include compounds each represented by H₂N—Ar₄—NH₂, and examples of Ar₄ include aromatic diamine residues represented by the following formulae.

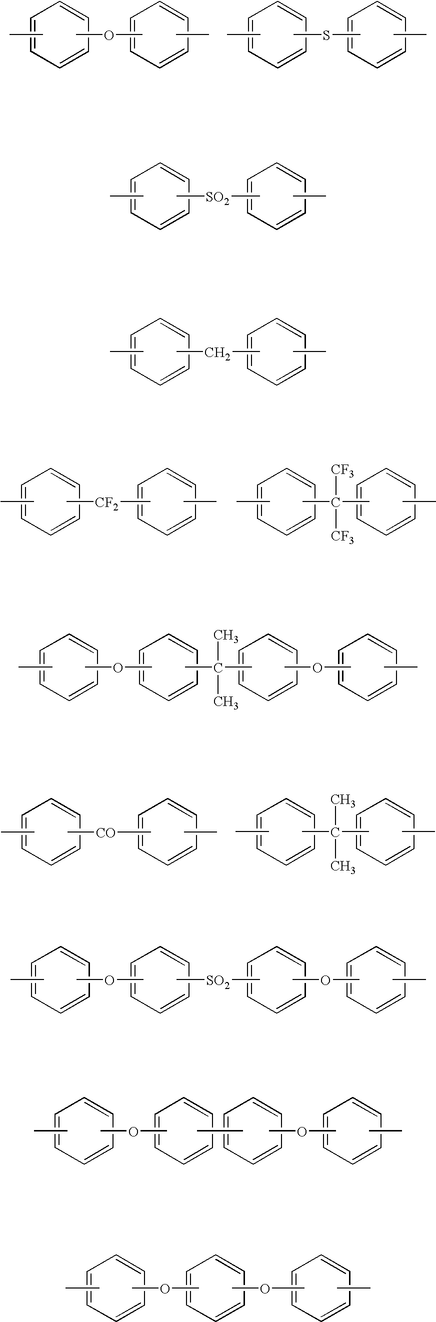

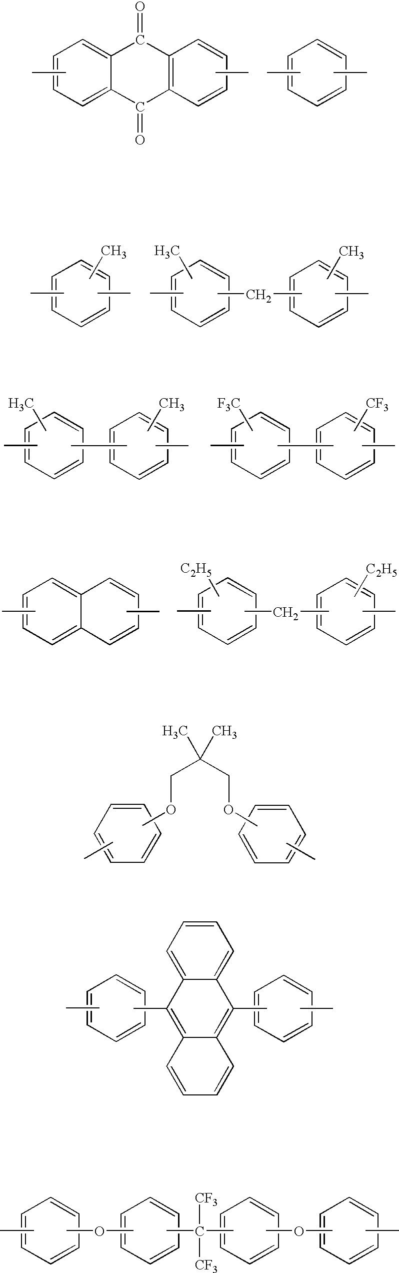

Of those, 4,4′-diaminodiphenylether (4,4′-DAPE), 1,3-bis(4-aminophenoxy)benzene (TPE-R), 1,3-bis(3-aminophenoxy)benzene (APB), and 2,2-bis(4-aminophenoxyphenyl)propane (BAPP) are suitable examples.

In addition, examples of the acid anhydride include compounds each represented by O(OC)₂Ar₅(CO)₂), and examples of Ar₅ include aromatic acid dianhydride residues represented by the following formulae.

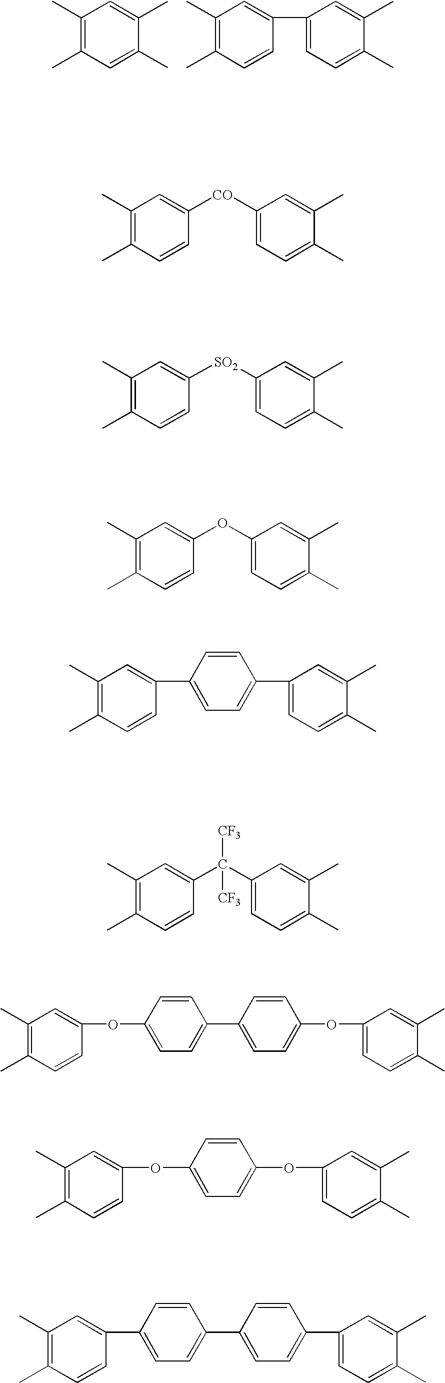

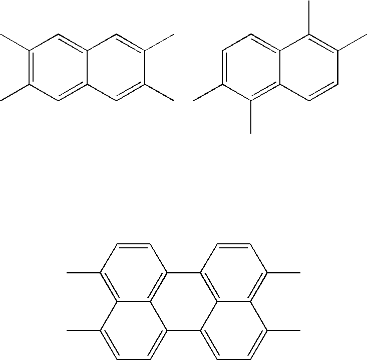

Of those, pyromellitic dianhydride (PMDA), 3,3′,4,4′-biphenyltetracarboxylic dianhydride (BPDA), 3,3′,4,4′-benzophenonetetracarboxylic dianhydride (BTDA), and 3,3′,4,4′-diphenylsulfonetetracarboxylic dianhydride (DSDA) are suitable examples.

As can be understood from the description of the above general formulae (1), (2), and (3), the diamine as a polyimide resin raw material of which the polyimide resin layer (A) is constituted is, for example, TPE-R, APB, or 4,4′-DAPE, and the acid anhydride as another polyimide resin raw material of which the polyimide resin layer (A) is constituted is PMDA. In addition, two or more diamines and two or more acid anhydrides (in other words, a total of four or more materials) may be used, or a diamine and an acid anhydride except those described above may be used as polyimide resin raw materials of which the polyimide resin layer (A) is constituted as long as the above formulae and the above molar ratios are satisfied.

The molecular weight of such polyimide resin can be controlled mainly on the basis of the molar ratios of the diamine and the acid anhydride as raw materials. The polyimide resin of which the polyimide resin layer (A) is constituted is obtained by imidating a precursor (solution) for the resin. In addition, when a polyimide resin layer having good adhesiveness is used as the other polyimide resin layer, the other polyimide resin layer is advantageously provided so as to be in contact with the metal layer, and the polyimide resin layer (A) is advantageously provided so as to be in contact with the other polyimide resin layer. Even when two or more kinds of the polyimide resin layers (A) are used, the polyimide resin layer (A) having relatively good adhesiveness as compared to that of any other layer is desirably provided so as to be in contact with the metal layer.

Examples of the metal layer include metal layers each formed of a conductive metal such as copper, aluminum, iron, silver, palladium, nickel, chromium, molybdenum, tungsten, zinc, or an alloy containing two or more of these metals. Of those, a stainless steel foil, a copper foil, or an alloy copper foil containing 90% or more of copper is preferable. The surface roughness (Rz) of the surface of the metal layer in contact with the polyimide resin layer is preferably 3.5 μm or less, and an electrolytic copper foil having a surface roughness Rz of 1.5 μm or less is more preferable. A copper foil or an alloy copper foil containing 90% or more of copper is preferably used as a metal layer for a laminate for a flexible wiring board; it is preferable that a stainless steel foil be used as a metal layer on one surface of a laminate for an HDD suspension, and a copper foil or an alloy copper foil containing 90% or more of copper be used as a metal layer on the other surface of the laminate.

When the polyimide resin layer is formed of multiple layers, a resin layer except the polyimide resin layer (A) is preferably provided so as to be adjacent to at least one surface of the polyimide resin layer (A). When the polyimide resin layer (A) is represented as a (A) layer, the other polyimide resin layer except the polyimide resin layer (A) is represented as a (II) layer, and the metal layer is represented as an M layer, examples of a preferable order in which the layers of a laminate for a flexible wiring board are laminated in the present invention include the following structures:
M layer/(A) layer;
M layer/(A) layer/(II)layer;
M layer/(II)layer/(A) layer;
M layer/(II)layer/(A) layer/(II)layer;
M layer/(A)layer/(A) layer/(A)layer;
M layer/(A)layer/(II) layer/(A)layer;
M layer/(A) layer/(II)layer/M layer; and
M layer/(II)layer/(A) layer/(II)layer/M layer.

In the present invention, multiple kinds of the polyimide resin layers (A) in each of which the kinds, molar ratios, and the like of the structural units are changed in the range of the general formulae (1), (2), and (3) may be provided like the above “M layer/(A)layer/(A) layer/(A)layer” structure. A laminate which: satisfies heat resistance requested at the time of implementation; has a sprocket hole that hardly undergoes rupture or the like; and is additionally suitable for a COF application can be obtained by making contrivance to a laminated constitution as described above. It should be noted that the M layers are provided for both surfaces of a laminate for an HDD suspension.

A polyimide resin is preferably formed on the metal layer by directly applying the resin in a polyimide precursor state onto a metal foil. In this case, the viscosity of a polymerized resin preferably falls within the range of 500 to 70,000 cps. When a polyimide insulating layer is composed of multiple layers, the layers can be formed by sequentially applying, onto a polyimide precursor resin, any other polyimide precursor resin composed of a component different from that of the former resin. When the polyimide insulating layer is composed of three or more layers, one polyimide precursor resin may be used twice or more. It should be noted that the surface of the metal layer as a surface to which a resin solution is to be applied may be appropriately treated before the resin solution is applied.

The laminate for a wiring board of the present invention can be produced by applying a polyimide precursor resin onto a metal foil as described above; the laminate can be produced also by laminating one or more polyimide films on a copper foil. A laminate for a wiring board produced as described above may be a single-side laminate for a wiring board having a metal foil only on one side of the laminate, or may be a double-side laminate for a wiring board having a metal foil on each of both sides of the laminate. A laminate using a copper foil as the metal foil out of the single-side laminates for wiring boards is referred to as a single-side copper-clad laminate; a laminate using a copper foil as the metal foil out of the double-side laminates for wiring boards is referred to as a double-side copper-clad laminate. The double-side laminate for a wiring board can be obtained by, for example, a method involving forming a single-side laminate for a wiring board and bringing a metal foil into press contact with the laminate by hot pressing, or a method involving sandwiching a polyimide film between two metal foil layers and bringing them into press contact with one another by hot pressing. When the laminate for a wiring board of the present invention is a laminate for a flexible wiring board, a single-side copper-clad laminate, a double-side copper-clad laminate, or the like is suitable. When the laminate for a wiring board of the present invention is a laminate for an HDD suspension, a double-side laminate for a wiring board having a conductor layer such as a copper foil on one side of the laminate and an elastic metal layer such as a stainless steel foil on the other side of the laminate is suitable. It should be noted that a method of producing a flexible wiring board or an HDD suspension from a laminate for a wiring board is known. An example of the method is a method involving etching a metal foil layer to form a predetermined circuit.

Various fillers or additives may be incorporated into the polyimide resin layer to such an extent that the object of the present invention is not impaired.

The laminate for a flexible wiring board of the present invention is suitable for a COF application. A flexible wiring board for COF of the present invention is obtained by providing a sprocket hole having a desired shape for an end portion of a flexible wiring board obtained by subjecting the above laminate for a flexible wiring board to wiring processing.

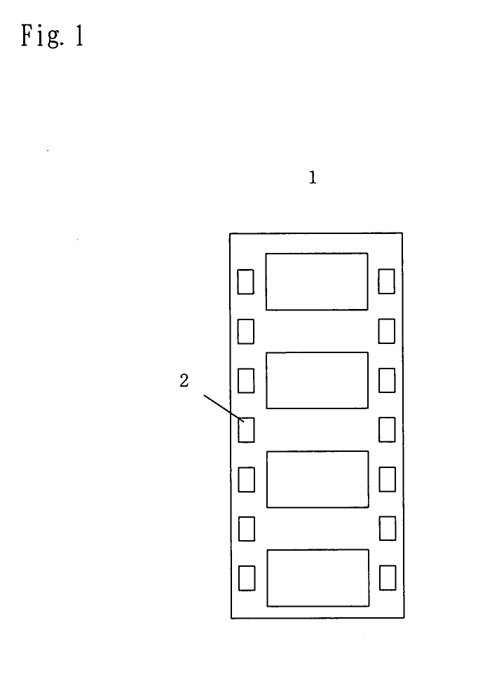

An example of a flexible wiring board for COF will be described with reference to FIG. 1 showing a plan view of the flexible wiring board. A method of producing a flexible wiring board 1 for COF is not particularly limited; a general method involves forming sprocket holes 2 at a certain interval in both side-ends of a laminate composed of a polyimide resin layer and a metal foil, forming an arbitrary wiring circuit, and forming a solder resist layer.

To be specific, first, a laminate for a flexible wiring board is slit at a predetermined width (for example, 35 mm) to be of a tape shape, and is perforated with the sprocket holes 2 in both of its side end portions with respect to its width direction. The tape is perforated with apertures each having a desired shape with a die in ordinary cases. An example of such product is a tape perforated with square holes 1.98 mm on a side at an interval of 4.75 mm. Next, a conductor is patterned through the following steps: the application of a photosensitive resin, the patterning of a photosensitive resin layer by a photographic method, the etching of a conductor layer with an acid, and the peeling of the photosensitive resin layer. An upper portion of the patterned conductor is additionally subjected to a plating treatment such as electroless plating or electroless nickel-gold plating, and the conductor layer is covered with a permanent resist, whereby a flexible wiring board for COF can be obtained.

The flexible wiring board thus obtained has a predetermined wiring circuit pattern on a polyimide base material, the surface of a copper-foil is covered with plating, and, furthermore, the conductor except a portion necessary for connection is protected with an insulator. In addition, the flexible wiring board is of a tape-like shape, and has sprocket holes for conveyance in both of its side end portions. Semiconductors such as an IC for driving liquid crystal are implemented on the flexible wiring board for COF, and the resultant is sealed with an insulating resin, divided into pieces for the respective semiconductors, and connected to, for example, a liquid crystal panel. In those processes, a chain sprocket wheel, that is, the so-called sprocket is combined with each sprocket hole so that the tape is conveyed. In this case, when the strength of a sprocket portion is insufficient, a problem, that is, the breakage of the tape from a sprocket hole occurs. Hereinafter, the contents of the present invention will be specifically described by way of examples. However, the present invention is not limited to the scope of these examples.

Abbreviations used in examples and the like are shown below.
PMDA: Pyromellitic dianhydride
BPDA: 3,3′,4,4′-biphenyltetracarboxylic dianhydride
BTDA: 3,3′,4,4′-benzophenonetetracarboxylic dianhydride
TPE-Q: 1,4-bis(4-aminophenoxy)benzene
TPE-R: 1,3-bis(4-aminophenoxy)benzene
APB: 1,3-bis(3-aminophenoxy)benzene
m-TB: 2,2′-dimethylbenzidine
PDA: 1,4-diaminobenzene
BAPP: 2,2-bis(4-aminophenoxyphenyl)propane
NBOA: 2,7-bis(4-aminophenoxy)naphthalene
3,4′-DAPE: 3,4′-diaminodiphenylether
4,4′-DAPE: 4,4′-diaminodiphenylether
DANPG: 1,3-bis(4-aminophenoxy)-2,2-dimethylpropane
DMAc: N,N-dimethylacetamide

In addition, methods of, and conditions for, measuring various physical properties in the examples are shown below. It should be noted that the expression “polyimide film” appearing in the following description refers to a polyimide film obtained by removing the copper foil of a laminate for a wiring board (which may hereinafter be referred to as “CCL”) by etching.

Measurement of tear Propagation Resistance

A test piece measuring 63.5 mm by 50 mm was prepared. A slit having a length of 12.7 mm was made in the test piece, and the tear propagation resistance of a CCL or a PI was measured with a light load tearing tester manufactured by Toyo Seiki Seisaku-Sho, Ltd. It should be noted that the term “CCL tear propagation resistance” refers to the measured tear propagation resistance of a CCL composed of a metal layer and a polyimide resin layer, and the term “PI tear propagation resistance” refers to the measured tear propagation. resistance of a polyimide film obtained by removing the copper foil of the CCL by etching. In addition, the term “polyimide film” refers to a polyimide film obtained by removing the copper foil of the CCL by etching.

Measurement of coefficient of Thermal Expansion (CTE)

A polyimide film (measuring 3 mm by 15 mm) was subjected to a tensile test in the temperature range of 30° C. to 260° C. at a rate of temperature increase of 20° C./min while a load of 5.0 g was applied to the film with an apparatus for thermomechanical analysis (TMA). A coefficient of thermal expansion was determined from the amount in which the polyimide film elongated with respect to a temperature.

Glass Transition Temperature (Tg), Storage Modulus (E′)

The dynamic viscoelasticity of a polyimide film (measuring 10 mm by 22.6 mm) was measured when the temperature of the film was increased from 20° C. to 500° C. at 5° C./min in DMA. The glass transition temperature Tg (local maximum value of tand) and storage modulus at 400° C. (E′) of the film were determined from the result of the measurement.

Measurement of Adhesive Strength

An adhesive force was determined as follows: the resin side of a CCL having a width of 1 mm was fixed to an aluminum plate with a double-faced tape, and a peel strength was determined with a tension tester by peeling copper in a 180° direction at a rate of 50 mm/min.

Measurement of Adhesive Strength (Stainless Steel Foil)

An adhesive force was determined as follows: the resin side of a laminate having a width of 1 mm was fixed to an aluminum plate with a double-faced tape, and a peel strength was determined with a tension tester by peeling a stainless steel foil in a 900 direction at a rate of 50 mm/min.

PI Etching Rate

An etching rate is measured by using: a laminate obtained by forming a polyimide layer on a metal foil; and a standard etchant (ethylenediamine 11.0 wt %, ethylene glycol 22.0 wt %, potassium hydroxide 33.5 wt %). First, the thickness of the entirety of the laminate obtained by forming the polyimide layer on the metal foil was measured. Next, the laminate was immersed in the above standard etchant at 80° C. in a state where the metal foil was left, and a time period required for the polyimide layer to disappear completely was measured. A value determined by dividing the initial thickness by the time period required for the etching was defined as an etching rate.

Measurement of Moisture Absorptivity

A polyimide film (measuring 4 cm by 20 cm) was dried at 120° C. for 2 hours. After that, the film was left standing in a thermo-hygrostat at 23° C./50% RH for 24 hours. The moisture absorptivity of the film was determined from the following equation on the basis of a change from the weight of the film before the leaving to that after the leaving:
Moisture absorptivity (%)=[(weight after moisture absorption−weight after drying)/weight after drying]×100.
Measurement of Coefficient of Humidity Expansion (CHE)

An etching resist layer was provided on the copper foil of a polyimide/copper foil laminate measuring 35 cm by 35 cm, and was formed into a pattern in which 16 points each having a diameter of 1 mm were arranged at an interval of 10 cm on the four sides of a square 30 cm on a side. A portion of an etching resist aperture where the copper foil was exposed was etched, whereby a polyimide film for CHE measurement having 16 copper foil remaining points was obtained. The film was dried at 120° C. for 2 hours. After that, the film was left standing in a thermo-hygrostat at 23° C. and a humidity of each of 30% RH, 50% RH, and 70% RH for 24 hours. The coefficient of humidity expansion (ppm/% RH) of the film was determined from a dimensional change between copper foil points at each humidity measured with a two-dimensional length measuring machine.

Evaluation for MIT Folding Resistance

A test was performed by using an MIT flexing fatigue resistance tester DA type manufactured by Toyo Seiki Seisaku-Sho, Ltd. A CCL was cut into a slit measuring 15 mm wide by 130 mm length or more long in size, and was processed into a circuit pattern having an L/S of 150/200 μm. Then, the number of times of bending which the slit was able to resist was measured. It should be noted that the measurement was performed under the following conditions: a load of 500 g, a bending angle of 270°, a bending rate of 175 rpm, and a bending radius R of 0.8 mm.

Evaluation for Conveying Property

Evaluation for conveying property based on the deformation of a sprocket hole was performed by: slitting a CCL into a tape shape having a width of 35 mm; and forming sprocket holes based on 35 super standards in both side end portions of the tape with a splicer for a TAB tape. Here, the sprocket holes were formed at a hole pitch of 4.75 mm, and each had a square shape 1.42 mm on a side, and a distance from an edge of the tape to the line passing through the centers of the holes was 0.6 mm. Then, the copper foil portion of the tape with sprocket holes was removed with a ferric chloride solution, whereby a polyimide film tape with sprocket holes was obtained. The tape was subjected to a roll-to-roll conveyance test in an OLB bonder. The symbol “O” means that the tape has good conveying property, while the symbol “X” means that the tape has bad conveying property.

PI Etching Shape

An electrolytic copper foil (having a thickness of 12 μm and a surface roughness Rz of 0.7 μm) was caused to overlap the insulating layer of a laminate having the insulating layer on a stainless steel foil, and was brought into press contact with the insulating layer under heat with a vacuum pressing machine under a contact pressure of 15 MPa at a temperature of 320° C. for a pressing time of 20 minutes. Next, an etching resist layer was formed on the copper foil surface of the laminate by a known method. After that, the resultant was immersed in an aqueous solution of ferric chloride at 38° C. for 20 seconds so that the copper foil was selectively removed. After that, an exposed polyimide resin layer was etched with the copper foil as an etching mask by being immersed in an etching aqueous solution containing 11.0 wt % of ethylenediamine, 22.0 wt % of ethylene glycol, and 33.5 wt % of potassium hydroxide to have a predetermined pattern, and the shape of the layer after the etching was observed with a microscope.

### EXAMPLE

### Synthesis Examples 1 to 13

In order that each of polyimide precursor resins A to K, U, and V might be synthesized, in a stream of nitrogen, a diamine shown in Table 1 was dissolved in about 250 to 300 g of a solvent DMAC while being stirred in a 500-ml separable flask. Next, a tetracarboxylic dianhydride shown in Table 1 was added to the solution. After that, a polymerization reaction was performed by continuously stirring the solution at room temperature for 4 hours, whereby a yellow to brown viscous solution of each of the polyimide precursor resins (polyamic acids) A to K, U, and V was obtained. The viscosities at 25° C. of the respective polyimide precursor resin solutions were measured and summarized in Table 1. It should be noted that the viscosities were each measured with a cone plate viscometer with a thermostat (manufactured by TOKIMEC INC.) at 25° C. In addition, Table 1 shows the weight average molecular weight (Mw) of each resin measured by GPC. It should be noted that the amount of each of a diamine and a tetracarboxylic dianhydride in Table 1 is represented in a “g” unit.

TABLE 1

| | Synthesis Example | | | | | | |
|---|---|---|---|---|---|---|---|
| | 1 | 2 | 3 | 4 | 5 | 6 | 7 |
| PMDA | 17.82 | 17.52 | 19.34 | 17.82 | 17.5 | 18.31 | 17.5 |
| BTDA | — | — | — | — | — | — | — |
| m-TB | 15.77 | 13.75 | 13.31 | 15.77 | 13.76 | 12.76 | 13.76 |
| TPE-R | 2.41 | 4.73 | 7.85 | — | — | — | — |
| APB | — | — | — | 2.41 | 4.74 | — | — |
| NBOA | — | — | — | — | — | 5.49 | — |
| TPE-Q | — | — | — | — | — | — | 4.74 |
| 3,4′-DAPE | — | — | — | — | — | — | — |
| 4,4′-DAPE | — | — | — | — | — | — | — |
| BAPP | — | — | — | — | — | — | — |
| DANPG | — | — | — | — | — | — | — |
| DMAc | 264 | 264 | 260 | 264 | 264 | 268 | 264 |
| Polyamic acid | A | B | C | D | E | F | G |
| Viscosity | 29200 | 37500 | 52500 | 42000 | 14100 | 30000 | 29200 |
| cP | | | | | | | |
| Mw ×10³ | 210 | 284 | 301 | 239 | 160 | 180 | 220 |
| Solid content | 12 | 12 | 13.5 | 12 | 12 | 12 | 12 |
| Wt % | | | | | | | |

| | Synthesis Example | | | | | |
|---|---|---|---|---|---|---|
| | 8 | 9 | 10 | 11 | 12 | 13 |
| PMDA | 18.31 | 18.31 | 11.42 | 17.55 | 6.03 | 14.37 |
| BTDA | — | — | — | — | 13.37 | 5.31 |
| m-TB | 12.6 | 12.6 | 0.81 | 15.77 | | |
| TPE-R | — | — | — | 2.41 | | |
| APB | — | — | — | — | | 23.83 |
| NBOA | — | — | — | — | | |
| TPE-Q | — | — | — | — | | |
| 3,4′-DAPE | 5.09 | — | — | — | | |
| 4,4′-DAPE | — | 5.09 | 0.56 | — | | |
| BAPP | — | — | 21.71 | — | | |
| DANPG | — | — | — | — | 19.6 | |
| DMAc | 264 | 264 | 266 | 203 | 261 | 257 |
| Polyamic acid | H | I | J | K | U | V |
| Viscosity | 9800 | 23600 | 1500 | 21200 | | |
| cP | | | | | | |
| Mw ×10³ | 200 | 205 | 170 | 120 | | |
| Solid content | 12 | 12 | 11.5 | 15 | | |
| Wt % | | | | | | |

### Examples 1 to 6

A solution of each of the polyimide precursor resins A to F was applied onto a copper foil A (electrolytic copper foil having a thickness of 12 μm and a surface roughness Rz of 0.7 μm) with an applicator, and was dried at 50 to 130° C. for 2 to 60 minutes. After that, the resultant was additionally subjected to a heat treatment at 130° C., 160° C., 200° C., 230° C., 280° C, 320° C., and 360° C. in stages for 2 to 30 minutes in each stage, whereby a polyimide layer was formed on the copper foil, and a CCL was obtained.

The copper foil was removed by etching with an aqueous solution of ferric chloride, whereby each of film-shaped polyimides A to F was produced. Then, the tear propagation resistance, coefficient of thermal expansion (CTE), glass transition temperature (Tg) storage modulus at 400° C. (E′), 180° peel strength, PI etching rate, and moisture absorptivity of each polyimide were determined. Table 2 shows the results.

It should be noted that the polyimide films A to K were obtained from the polyimide precursors A to K.

### Comparative Examples 1 to 4 and Reference Example 1

A polyimide film was obtained in the same manner as in Example 1 except that each of the polyimide precursor resins G to K obtained in Synthesis Examples 7 to 11 was used as a polyimide precursor resin. Table 2 shows the characteristics of the polyimide films G to K.

TABLE 2

| | | | | | | | | | | | Reference |
|---|---|---|---|---|---|---|---|---|---|---|---|
| | Example | | | | | | Comparative Example | | | | Example |
| Evaluation item | 1 | 2 | 3 | 4 | 5 | 6 | 1 | 2 | 3 | 4 | 1 |
| Polyimide film | A | B | C | D | E | F | G | H | I | K | J |
| Thickness μm | 29 | 27 | 26 | 27 | 25 | 29 | 26 | 23 | 26 | 38 | 16 |
| Tear propagation | 153 | 147 | 260 | 140 | 181 | 150 | 91 | 94 | 68 | 80 | 48 |
| resistance mN | | | | | | | | | | | |
| CTE ppm/K | 12 | 15 | 24 | 8 | 22 | 16 | 8 | 14 | 8 | 15 | 56 |
| Tg ° C. | 394 | 374 | 359 | 386 | 361 | 370 | 391 | 398 | 404 | 395 | 311 |
| E′ (400° C.) Gpa | 1.1 | 0.5 | 0.2 | 0.8 | 0.2 | 0.4 | 1 | 0.7 | 1 | 1.1 | 0.03 |
| Peel strength kN/m | 0.71 | 0.91 | 1.1 | 0.75 | 1.03 | 0.85 | 0.63 | 0.69 | 0.49 | 0.69 | 1.3 |
| PI etching rate | 13 | 14 | 14 | 11 | 12 | 10 | | | | | |
| μm/min | | | | | | | | | | | |
| Moisture absorptivity | 1.1 | 0.9 | 0.7 | 0.9 | 0.8 | 0.9 | | | | | |
| wt % | | | | | | | | | | | |

A film made of the polyimide precursor resin K obtained in Synthesis Example 11 has a small tear propagation resistance because the resin has a low molecular weight. It should be noted that the polyimide precursor resin J provides a polyimide resin having good adhesiveness.

### Example 7

A solution of the polyimide precursor resin B prepared in Synthesis Example 2 was uniformly applied onto the copper foil A so that the thickness of the resin would be 1.5 μm after curing. Then, the resultant was dried under heat at 130° C., whereby the solvent was removed. Next, a solution of the polyimide precursor resin C prepared in Synthesis Example 3 was uniformly applied onto the resultant so that the thickness of the resin would be 21 μm after curing. Then, the resultant was dried under heat at 70 to 130° C., whereby the solvent was removed. Further, a solution of the polyimide precursor resin B was uniformly applied onto the resultant so that the thickness of the resin would be 2.5 μm after curing. Then, the resultant was dried under heat at 140° C., whereby the solvent was removed. After that, the resultant was imidated by heat treatment at 130° C., 160° C., 200° C., 230° C., 280° C., 320° C., and 360° C. in stages for 2 to 30 minutes in each stage, whereby a laminate having an insulating resin layer composed of three polyimide resin layers and having a total thickness of 25 μm formed on the copper foil was obtained. The respective polyimide resin layers B, C, and B on the copper foil had thicknesses of 1.5 μm, 21 μm, and 2.5 μm, respectively. After that, the copper foil was etched with a hydrogen peroxide/sulfuric acid-based etchant to have a thickness of 8 μm, whereby a CCL (Ml) was obtained.

### Example 8

A solution of the polyimide precursor resin B prepared in Synthesis Example 2 was uniformly applied onto the copper foil A so that the thickness of the resin would be 23 μm after curing. Then, the resultant was dried under heat at 70 to 130° C., whereby the solvent was removed. Next, a solution of the polyimide precursor resin J prepared in Synthesis Example 10 was uniformly applied onto the resultant so that the thickness of the resin would be 2 μm after curing. Then, the resultant was dried under heat at 140° C., whereby the solvent was removed. After that, the resultant was imidated by a heat treatment at 130° C., 160° C., 200° C., 230° C., 280° C., 320° C., and 360° C. in stages for 2 to 30 minutes in each stage, whereby a laminate having an insulating resin layer composed of two polyimide resin layers and having a total thickness of 25 μm formed on the copper foil was obtained. The respective polyimide resin layers B and J on the copper foil had thicknesses of 23 μm and 2 μm, respectively. After that, the copper foil was etched with a hydrogen peroxide/sulfuric acid-based etchant to have a thickness of 8 μm, whereby a CCL (M2) was obtained.

### Example 9

A CCL (M3) was obtained in the same manner as in Example 8 except that the polyimide resin layers B and J had thicknesses of 27 μm and 3 μm, respectively.

### Comparative Example 5

A solution of the polyimide precursor resin K prepared in Synthesis Example 11 was uniformly applied onto the copper foil A. Then, the resultant was dried under heat at 130° C., whereby the solvent was removed. Next, the resultant was imidated by a heat treatment at 130° C., 160° C., 200° C., 230° C., 280° C., 320° C., and 360° C. in stages for 2 to 30 minutes in each stage, whereby a laminate having an insulating resin layer composed of three polyimide resin layers and having a total thickness of 38 μm formed on the copper foil was obtained. After that, the copper foil was etched with a hydrogen peroxide/sulfuric acid-based etchant to have a thickness of 8 μm, whereby a CCL (M4) was obtained. Table 3 shows the results of the evaluation of the laminate for characteristics.

TABLE 3

| | | | | Comparative |
|---|---|---|---|---|
| | Example 7 | Example 8 | Example 9 | Example 5 |
| Laminate | M1 | M2 | M3 | M4 |
| PI layer thickness | 25 | 25 | 30 | 38 |
| μm | | | | |
| PI tear propagation | 241 | 140 | 200 | 80 |
| resistance mN | | | | |
| CCL tear propagation | 435 | 370 | 430 | 280 |
| resistance mN | | | | |
| CTE ppm/K | 18 | 25 | 20 | 15 |
| Tg ° C. | 368 | 366 | 378 | 395 |
| E′ (400° C.) GPa | 0.29 | 0.29 | 0.49 | 1.1 |
| Peel strength KN/m | 0.9 | 0.8 | 1.1 | 0.68 |
| Moisture absorptivity | 0.8 | 0.8 | 0.9 | 1.0 |
| wt % | | | | |
| CHE ppm/RH % | 10 | 11 | 13 | 11 |
| MIT folding resistance | 408 | 408 | 307 | 170 |
| Evaluation for | ◯ | ◯ | ◯ | X |
| conveying property | | | | |

Evaluation for conveying property based on the deformation of a sprocket hole was performed. As a result, a CCL of each of Examples 7 to 9 showed good conveying property, but, in Comparative Example 4, a tape made of polyimide ruptured. In addition, in each of the CCL's (M1) to (M3) obtained in Examples 7 to 9, a polyimide resin layer is constituted of multiple layers, and any other layer except the polyimide resin layer (A) is responsible for control which a polyimide layer composed of a single layer hardly achieves such as curl control or the control of adhesiveness with a metal foil while the polyimide resin layer (A) secures a balance between the tear strength and any other characteristic of the polyimide resin layer as a major feature of the present invention. In particular, each of the CCL's provides a flexible wiring board for COF causing no subduction of wiring at the time of the implementation of a semiconductor element at a high temperature of about 400° C. As can be seen from Table 3, each of the CCL's (M1) to (M3) is a laminate having a high adhesive strength, high heat resistance, high tear propagation resistance, and a low moisture absorptivity, and each of them shows an MIT folding resistance of 300 times or more, that is, each of them is excellent in flexing resistance.

### Examples 10 to 14

A solution of the polyimide precursor resin B was applied onto the copper foil A with an applicator with the thickness of the solution changed in each example, and was dried at 50 to 130° C. for 2 to 60 minutes. After that, the resultant was additionally subjected to a heat treatment at 130° C., 160° C., 200° C., 230° C., 280° C., 320° C., and 360° C. in stages for 2 to 30 minutes in each stage, whereby a CCL having a polyimide resin layer having a thickness shown in Table 4 formed on the copper foil was obtained.

The copper foil was removed by etching with an aqueous solution of ferric chloride, whereby each of polyimide films L to P was produced. Then, the tear propagation resistance, coefficient of thermal expansion (CTE), PI etching rate, and moisture absorptivity of each polyimide film were determined. Table 4 shows the results.

TABLE 4

| | | Example | | | | |
|---|---|---|---|---|---|---|
| | | 10 | 11 | 12 | 13 | 14 |
| Polyimide film | | L | M | N | O | P |
| Thickness | μm | 9.2 | 12.1 | 14.0 | 23.5 | 35.0 |
| Tear propagation | mN | 25 | 37 | 52 | 127 | 245 |
| resistance | | | | | | |
| CTE | ppm/K | 7 | 11 | 21 | 27 | 23 |
| PI etching rate | μm/min | 27 | | 18 | 14 | 11 |
| Moisture absorptivity | wt % | 0.5 | | 0.8 | 0.9 | 0.8 |

### Examples 15 to 17

Polyimide precursor resins having different weight average molecular weights (Mw) were each synthesized in the same manner as in Synthesis Example 2 except that a molar ratio of a tetracarboxylic dianhydride to a diamine (acid dianhydride/diamine) was changed to 0.985, 0.988, or 0.991. A solution of each of those polyimide precursor resins was applied onto the copper foil A with an applicator, and was dried at 50 to 130° C. for 2 to 60 minutes. After that, the resultant was additionally subjected to a heat treatment at 130° C., 160° C., 200° C., 230° C., 280° C., 320° C., and 360° C. in stages for 2 to 30 minutes in each stage, whereby a polyimide layer was formed on the copper foil, and a CCL was obtained.

The copper foil was removed by etching with an aqueous solution of ferric chloride, whereby each of polyimide films Q to S was produced. Then, the tear propagation resistance and coefficient of thermal expansion (CTE) of each polyimide film were determined.

### Comparative Example 6

A polyimide precursor resin was synthesized in the same manner as in Synthesis Example 2 except that a molar ratio of a tetracarboxylic dianhydride to a diamine (acid dianhydride/diamine) was changed to 0.980. A solution of the polyimide precursor resin was applied onto an electrolytic copper foil having a thickness of 12 μm (surface roughness Rz: 0.7 μm) with an applicator, and was dried at 50 to 130° C for 2 to 60 minutes. After that, the resultant was additionally subjected to a heat treatment at 130° C., 160° C., 200° C., 230° C., 280° C., 320° C., and 360° C. in stages for 2 to 30 minutes in each stage, whereby a polyimide layer was formed on the copper foil, and a CCL was obtained.

The copper foil was removed by etching with an aqueous solution of ferric chloride, whereby a polyimide film T was produced. Then, the tear propagation resistance and coefficient of thermal expansion (CTE) of the polyimide film were determined. Table 5 shows the results.

TABLE 5

| | | Example | Example | Example | Comp. |
|---|---|---|---|---|---|
| | | 15 | 16 | 17 | Example 6 |
| Polyimide film | | Q | R | S | T |
| Acid dianhydride/diamine | | 0.985 | 0.988 | 0.991 | 0.980 |
| molar ratio | | | | | |
| Mw | | 168,000 | 209,000 | 244,000 | 142,000 |
| Thickness | μm | 25.5 | 23.3 | 26.6 | 25.9 |
| Tear propagation | mN | 113 | 115 | 132 | 93 |
| resistance | | | | | |
| CTE | ppm/K | 16 | 15 | 16 | 17 |

### Examples 18 to 20

A solution of the polyimide precursor resin B was applied onto the copper foil A with an applicator with the thickness of the solution changed in each example, and was dried at 50 to 130° C. for 2 to 60 minutes. After that, the resultant was additionally subjected-to a heat treatment at 130° C., 160° C., 200° C., 230° C., 280° C., 320° C., and 360° C. in stages for 2 to 30 minutes in each stage, whereby each of CCL's (M5) to (M7) each having a polyimide resin layer having a thickness shown in Table 6 formed on the copper foil was obtained. Each of the resultant CCL's was tested for MIT folding resistance. Table 6 shows the results.

TABLE 6

| | | PI layer | MIT folding |
|---|---|---|---|
| | | thickness | resistance |
| | CCL | μm | Times |
| Example 18 | M5 | 11 | 797 |
| Example 19 | M6 | 21 | 356 |
| Example 20 | M7 | 30 | 183 |

### Example 21

A solution of the polyimide precursor resin U prepared in Synthesis Example 12 was uniformly applied onto a stainless steel foil A (stainless steel foil having a thickness of 20 μm, SUS304 manufactured by NIPPON STEEL CORPORATION.) so that the thickness of the resin would be 1.0 μm after curing. Then, the resultant was dried under heat at 110° C., whereby the solvent was removed. Next, a solution of the polyimide precursor resin B prepared in Synthesis Example 2 was uniformly applied onto the resultant so that the thickness of the resin would be 7.5 μm after curing. Then, the resultant was dried under heat at 110° C., whereby the solvent was removed. Further, a solution of the polyimide precursor resin V was uniformly applied onto the resultant so that the thickness of the resin would be 1.5 μm after curing. Then, the resultant was dried under heat at 110° C., whereby the solvent was removed. After that, the resultant was imidated by a heat treatment at 130° C. to 360° C. in stages for 2 to 30 minutes in each stage, whereby a laminate having an insulating resin layer composed of three polyimide resin layers and having a total thickness of 10 μm formed on the stainless steel foil was obtained. The physical properties shown in Table 7 of the laminate were measured.

TABLE 7

| | | Example 21 |
|---|---|---|
| PI layer thickness | μm | 10 |
| PI tear propagation | mN | 18 |
| resistance | | |
| CTE | ppm/K | 23 |
| 1 mm peel strength | kN/m | 1.5 |
| Moisture absorptivity | wt % | 1.1 |
| PI etching rate | μm/min | 18 |
| PI etching shape | | Good |

### Synthesis Examples 14 to 26

In order that each of polyimide precursor resins A₂ to M₂ might be synthesized, in a stream of nitrogen, a diamine shown in Table 8 was dissolved in about 200 to 300 g of a solvent DMAc while being stirred in a 500-ml separable flask. Next, a tetracarboxylic dianhydride shown in Table 8 was added to the solution. After that, a polymerization reaction was performed by continuously stirring the solution at room temperature for 4 hours, whereby a yellow to brown viscous solution of each of the polyimide precursor resins (polyamic acids) A₂ to M₂ was obtained. The viscosities at 25° C. of the respective polyimide precursor resin solutions were measured and summarized in Table 8. It should be noted that the viscosities were each measured with a cone plate viscometer with a thermostat (manufactured by TOKIMEC INC.) at 25° C. In addition, Table 8 shows the weight average molecular weight (Mw) of each resin measured by GPC. The usage of each of a diamine and a tetracarboxylic dianhydride in Table 8 is represented in a “gram” unit.

TABLE 8

| | Synthesis Example | | | | | | |
|---|---|---|---|---|---|---|---|
| | 14 | 15 | 16 | 17 | 18 | 19 | 20 |
| PMDA | 17.55 | 17.55 | 17.55 | 17.55 | 17.55 | 17.55 | 17.4 |
| BPDA | — | — | — | — | — | — | — |
| m-TB | 12.08 | 12.08 | 12.08 | 12.08 | 12.08 | 12.08 | 13.68 |
| TPE-R | 4.75 | 4.75 | — | — | — | — | — |
| APB | — | — | 4.75 | 4.75 | — | — | — |
| NBOA | — | — | — | — | 4.75 | 4.75 | — |
| PDA | — | — | — | — | — | — | — |
| 3,4′-DAPE | 1.63 | — | 1.63 | — | 1.63 | — | 1.61 |
| 4,4′-DAPE | — | 1.63 | — | 1.63 | — | 1.63 | — |
| BAPP | — | — | — | — | — | — | 3.31 |
| DMAc | 264 | 264 | 264 | 264 | 264 | 264 | 264 |
| Polyamic | A₂ | B₂ | C₂ | D₂ | E₂ | F₂ | G₂ |
| acid | | | | | | | |
| Viscosity | 13200 | 19200 | 6000 | 8200 | 3400 | 8200 | 20000 |
| cP | | | | | | | |
| Mw ×10³ | 219 | 235 | 187 | 194 | 150 | 190 | 230 |
| Solid | 12 | 12 | 12 | 12 | 12 | 12 | 12 |
| content Wt % | | | | | | | |

| | Synthesis Example | | | | | |
|---|---|---|---|---|---|---|
| | 21 | 22 | 23 | 24 | 25 | 26 |
| PMDA | 17.4 | 17.26 | 17.35 | 11.42 | 17.52 | 17.55 |
| BPDA | — | | 5.85 | 0.81 | — | — |
| m-TB | 13.68 | 12.76 | 20.04 | — | 13.75 | 15.77 |
| TPE-R | — | — | — | — | 4.73 | 2.41 |
| APB | — | — | 1.76 | — | — | — |
| NBOA | — | 5.49 | — | — | — | — |
| PDA | — | 0.43 | — | — | — | — |
| 3,4′-DAPE | — | — | — | 0.56 | — | — |
| 4,4′-DAPE | 1.61 | — | — | — | — | — |
| BAPP | 3.31 | — | — | 21.71 | — | — |
| DMAc | 264 | 264 | 255 | 266 | 264 | 203 |
| Polyamic | H₂ | I₂ | J₂ | K₂ | L₂ | M₂ |
| acid | | | | | | |
| Viscosity | 19700 | 15000 | 35000 | 1500 | 37500 | 21200 |
| cP | | | | | | |
| Mw ×10³ | 210 | 80 | 120 | 170 | 284 | 120 |
| Solid | 12 | 12 | 15 | 11.5 | 12 | 15 |
| content Wt % | | | | | | |

### Examples 22 to 27

A solution of each of the polyimide precursor resins A₂ to F₂ was applied onto the copper foil A (electrolytic copper foil having a thickness of 12 μm and a surface roughness Rz of 0.7 μm) with an applicator, and was dried at 50 to 130° C. for 2 to 60 minutes. After that, the resultant was additionally subjected to a heat treatment at 130° C., 160° C., 200° C., 230° C., 280° C., 320.° C., and 360° C. in stages for 2 to 30 minutes in each stage, whereby a polyimide layer was formed on the copper foil, and a CCL was obtained.

The copper foil was removed by etching with an aqueous solution of ferric chloride, whereby each of polyimide films A₂ to F₂ was produced. Then, the tear propagation resistance, coefficient of thermal expansion (CTE), glass transition temperature (Tg), storage modulus at 400° C. (E′), 180° peel strength, PI etching rate, and moisture absorptivity of each polyimide film were determined.

It should be noted that the polyimides of the polyimide films A₂ to F₂ were obtained from the corresponding polyimide precursors A₂ to F₂.

### Comparative Examples 7 to 10

Polyimide films G₂ to I₂ and M₂ were each produced in the same manner as in Example 22 except that each of the polyimide precursor resins G₂ to I₂ and M₂ was used as a polyimide precursor resin. Then, the physical properties of each of the films were measured. Table 9 shows the characteristics of the polyimide films A₂ to I₂ and M₂.

| | Example | | | | | | Comparative Example | | | |
|---|---|---|---|---|---|---|---|---|---|---|
| Evaluation item | 22 | 23 | 24 | 25 | 26 | 27 | 7 | 8 | 9 | 10 |
| Polyimide film | A₂ | B₂ | C₂ | D₂ | E₂ | F₂ | G₂ | H₂ | I₂ | M₂ |
| Thickness μm | 24.6 | 25 | 23.6 | 24.3 | 26.2 | 27.3 | 25.6 | 25.7 | 28.5 | 38 |
| Tear propagation | 200 | 145 | 225 | 201 | 148 | 132 | 87 | 87 | 75 | 80 |
| resistance mN | | | | | | | | | | |
| CTE ppm/K | 22 | 17 | 25 | 24 | 19 | 20 | 17 | 9 | 16 | 15 |
| Tg ° C. | 365 | 367 | 350 | 343 | 370 | 373 | 389 | 390 | 370 | 395 |
| E′ (400° C.) GPa | 0.3 | 0.3 | 0.1 | 0.1 | 0.35 | 0.38 | 0.7 | 0.7 | 0.4 | 1.1 |
| Peel strength kN/m | 0.78 | 0.88 | 0.98 | 1.04 | 0.85 | 0.8 | 0.69 | 0.64 | 0.85 | 0.69 |
| PI etching rate | 14 | 12 | 13 | 12 | 9 | 7 | | | | |
| μm/min | | | | | | | | | | |
| Moisture absorptivity | 0.8 | 0.8 | 0.7 | 0.9 | 0.9 | 0.8 | | | | |
| wt % | | | | | | | | | | |

### Example 28

A solution of the polyimide precursor resin J₂ prepared in Synthesis Example 23 was uniformly applied onto the copper foil A so that the thickness of the resin would be 1.9 μm after curing. Then, the resultant was dried under heat at 130° C., whereby the solvent was removed. Next, a solution of the polyimide precursor resin A₂ prepared in Synthesis Example 14 was uniformly applied onto the resultant so that the thickness of the resin would be 21 μm after curing. Then, the resultant was dried under heat at 70 to 130° C., whereby the solvent was removed. Further, a solution of the polyimide precursor resin J₂ was uniformly applied onto the resultant so that the thickness of the resin would be 2.1 μm after curing. Then, the resultant was dried under heat at 140° C., whereby the solvent was removed. After that, the resultant was imidated by a heat treatment at 130° C., 160° C., 200° C., 230° C., 280° C., 320° C., and 360° C. in stages for 2 to 30 minutes in each stage, whereby a laminate having an insulating resin layer composed of three polyimide resin layers and having a total thickness of 25 μm formed on the copper foil was obtained. The respective polyimide resin layers J₂, A₂, and J₂ on the copper foil had thicknesses of 1.9 μm, 21 μm, and 2.1 μm, respectively. After that, the copper foil was etched with a hydrogen peroxide/sulfuric acid-based etchant to have a thickness of 8 μm, whereby a laminate (M8) as a CCL was obtained.

### Example 29

A laminate having an insulating resin layer composed of three polyimide resin layers and having a total thickness of 25 μm formed on a copper foil was obtained in the same manner as in Example 28 except that the polyimide precursor resin L₂ prepared in Synthesis Example 25 was used instead of the polyimide precursor resin J₂ prepared in Synthesis Example 23. The respective polyimide resin layers L₂, A₂, and L₂ on the copper foil had thicknesses of 1.9 μm, 21 μm, and 2.1 μm, respectively. After that, the copper foil was etched with a hydrogen peroxide/sulfuric acid-based etchant to have a thickness of 8 μm, whereby a laminate (M9) was obtained.

### Example 30

A solution of the polyimide precursor resin A₂ prepared in Synthesis Example 14 was uniformly applied onto the copper foil A so that the thickness of the resin would be 23 μm after curing. Then, the resultant was dried under heat at 70 to 130° C., whereby the solvent was removed. Next, a solution of the polyimide precursor resin K₂ prepared in Synthesis Example 24 was uniformly applied onto the resultant so that the thickness of the resin would be 2 μm after curing. Then, the resultant was dried under heat at 140° C., whereby the solvent was removed. After that, the resultant was imidated by a heat treatment at room temperature to 360° C. in 5 hours, whereby a laminate having an insulating resin layer composed of two polyimide resin layers and having a total thickness of 25 μm formed on the copper foil was obtained. The respective polyimide resin layers A₂ and K₂ on the copper foil had thicknesses of 23 μm and 2 μm, respectively. After that, the copper foil was etched with a hydrogen peroxide/sulfuric acid-based etchant to have a thickness of 8 μm, whereby a laminate (M10) was obtained.

### Comparative Example 11

A solution of the polyimide precursor resin M₂ prepared in Synthesis Example 2:6 was uniformly applied onto the copper foil A. After that, the resultant was imidated by a heat treatment at 130° C., 160° C., 200° C., 230° C., 280° C., 320° C., and 360° C. in stages for 2 to 30 minutes in each stage, whereby a laminate having an insulating resin layer having a thickness of 38 μm formed on the copper foil was obtained. After that, the copper foil was etched with a hydrogen peroxide/sulfuric acid-based etchant to have a thickness of 8 μm, whereby a laminate (M11) was obtained. Table 10 shows the results of the evaluation of the laminate for characteristics.

TABLE 10

| | Example | Example | Example | Comp. |
|---|---|---|---|---|
| Evaluation item | 28 | 29 | 30 | Example 11 |
| Laminate | M8 | M9 | M10 | M11 |
| PI layer thickness μm | 27 | 27 | 25 | 38 |
| PI tear propagation resistance | 235 | 251 | 200 | 80 |
| mN | | | | |
| CCL tear propagation resistance | 390 | 410 | 360 | 280 |
| mN | | | | |
| CTE ppm/K | 24 | 23 | 20 | 15 |
| Tg ° C. | 365 | 370 | 366 | 395 |
| E′ (400° C.) GPa | 0.28 | 0.39 | 0.22 | 1.1 |
| Peel strength kN/m | 0.8 | 0.9 | 1.2 | 0.68 |
| Moisture absorptivity wt % | 0.8 | 0.8 | 0.7 | 1.0 |
| CHE ppm/RH % | 10 | 11 | 10 | 11 |
| MIT folding resistance times | 367 | 362 | 410 | 170 |
| Evaluation for conveying property | ◯ | ◯ | ◯ | X |

In each of the laminate (M8) to (M10) obtained in Examples 28 to 30, a polyimide resin layer is constituted of multiple layers, and any other layer except the polyimide resin layer (A) is responsible for control which a polyimide layer composed of a single layer hardly achieves such as curl control or the control of adhesiveness with a metal foil while the polyimide resin layer (A) secures a balance between the tear strength and any other characteristic of the polyimide resin layer as a major feature of the present invention. In particular, each of the laminate provides a flexible wiring board for COF causing no subduction of wiring at the time of the implementation of a semiconductor element at a high temperature of about 400° C. As can be seen from Table 3, each of the laminate (M8) to (M10) is a laminate having a high adhesive strength, high heat resistance, high tear propagation resistance, and a low moisture absorptivity, and each of them shows an MIT folding resistance of 300 times or more, that is, each of them is excellent in flexing resistance. In addition, evaluation for conveying property based on the deformation of a sprocket hole was performed. As a result, a CCL of each of Examples 28 to 30 showed good conveying property, but, in Comparative Example 11, a tape made of polyimide ruptured.

### Examples 31 to 36

A solution of the polyimide precursor resin A₂ was applied onto the copper foil A with an applicator with the thickness of the solution changed in each example, and was dried at 50 to 130° C. for 2 to 60 minutes. After that, the resultant was additionally subjected to a heat treatment at 130° C., 160° C., 200° C., 230° C., 280° C., 320° C., and 360° C. in stages for 2 to 30 minutes in each stage, whereby a CCL having a polyimide resin layer having a thickness shown in Table 11 formed on the copper foil was obtained.

The copper foil was removed by etching with an aqueous solution of ferric chloride, whereby each of polyimide films 0 to T was produced. Then, the tear propagation resistance, coefficient of thermal expansion (CTE), PI etching rate, and moisture absorptivity of each polyimide film were determined. Table 11 shows the results.

TABLE 11

| | | Example | | | | | |
|---|---|---|---|---|---|---|---|
| | | 31 | 32 | 33 | 34 | 35 | 36 |
| Polyimide film | | O | P | Q | R | S | T |
| Thickness | μm | 10.8 | 14.0 | 21.8 | 27.6 | 33.9 | 39.8 |
| Tear propagation | mN | 34 | 54 | 143 | 220 | 298 | 366 |
| resistance | | | | | | | |
| CTE | ppm/K | 22 | 26 | 22 | 26 | 23 | 26 |
| PI etching rate | μm/min | 30 | 20 | | 14 | 10 | |
| Moisture | wt % | 0.6 | 0.7 | | 0.8 | 0.8 | |
| absorptivity | | | | | | | |

### Examples 37 and 38

Polyimide precursor resins having different weight average molecular weights (Mw) were each synthesized in the same manner as in Synthesis Example 14 except that a molar ratio of a tetracarboxylic dianhydride to a diamine (acid dianhydride/diamine) was changed to 0.990 or 0.996. A solution of each of those polyimide precursor resins was applied onto the copper foil A with an applicator, and was dried at 50 to 130° C. for 2 to 60 minutes. After that, the resultant was additionally subjected to a heat treatment at 130° C., 160° C., 200° C., 230° C., 280° C., 320° C., and 360° C. in stages for 2 to 30 minutes in each stage, whereby a polyimide layer was formed on the copper foil, and a CCL was obtained.

The copper foil was removed by etching with an aqueous solution of ferric chloride, whereby each of polyimide films X and Y was produced. Then, the tear propagation resistance and coefficient of thermal expansion (CTE) of each polyimide film were determined.

### Comparative Example 12

A polyimide precursor resin was synthesized in the same manner as in Synthesis Example 14 except that a molar ratio of a tetracarboxylic dianhydride to a diamine (acid dianhydride/diamine) was changed to 0.988. A solution of the polyimide precursor resin was applied onto a copper foil A with an applicator, and was dried at 50 to 130° C. for 2 to 60 minutes. After that, the resultant was additionally subjected to a heat treatment at 130° C., 160° C., 200° C., 230° C., 280° C., 320° C., and 360° C. in stages for 2 to 30 minutes in each stage, whereby a polyimide layer was formed on the copper foil, and a CCL was obtained.

The copper foil was removed by etching with an aqueous solution of ferric chloride, whereby a polyimide film Z was produced. Then, the tear propagation resistance and coefficient of thermal expansion (CTE) of the polyimide film were determined. Table 12 shows the results.

TABLE 12

| | | Example | Example | Comp. |
|---|---|---|---|---|
| | | 37 | 38 | Example 12 |
| Polyimide film | | X | Y | Z |
| Acid dianhydride/ | | 0.990 | 0.996 | 0.988 |
| diamine molar | | | | |
| ratio | | | | |
| Weight average | | 156,000 | 245,000 | 137,000 |
| molecular | | | | |
| weight (Mw) | | | | |
| Thickness | μm | 22.9 | 21.5 | 22.0 |
| Tear propagation | mN | 158 | 162 | 149 |
| resistance | | | | |
| CTE | ppm/K | 22 | 22 | 22 |

### Example 39

A solution of the polyimide precursor resin K₂ prepared in Synthesis Example 24 was uniformly applied onto the copper foil B (rolling copper foil having a tickness of 12 μm and a surface roughness R, of 1.0 μm) so that the thickness of the resin would be 1.6 μm after curing. Then, the resultant was dried under heat at 130° C., whereby the solvent was removed. Next, a solution of the polyimide precursor resin A₂ prepared in Synthesis Example 14 was uniformly applied onto the resultant so that the thickness of the resin would be 8.7 μm after curing. Then, the resultant was dried under heat at 70 to 130° C., whereby the solvent was removed. Further, a solution of the polyimide precursor resin K₂ was uniformly applied onto the resultant so that the thickness of the resin would be 1.7 μm after curing. Then, the resultant was dried under heat at 140° C., whereby the solvent was removed. After that, the resultant was imidated by a heat treatment at 130° C., 160° C., 200° C., 230° C., 280° C., 320° C., and 360° C. in stages for 2 to 30 minutes in each stage, whereby a CCL (M11) having an insulating resin layer composed of three polyimide resin layers and having a total thickness of 12 μm formed on the copper foil was obtained. The respective polyimide resin layers K₂, A₂, and K₂ on the copper foil had thicknesses of 1.6 μm, 8.7 μm, and 1.7 μm, respectively.

### Example 40

A CCL (M12) having an insulating resin layer composed of three polyimide resin layers and having a total thickness of 13.5 μm formed on a copper foil was obtained in the same manner as in Example 39 except that the thickness of the polyimide precursor resin A₂ after curing was 10.2 μm. The respective polyimide resin layers K₂, A₂, and K₂ on the copper foil had thicknesses of 1.6 μm, 10.2 μm, and 1.7 μm, respectively.

### Comparative Example 13

A solution of the polyimide precursor resin M₂ prepared in Synthesis Example 26 was uniformly applied onto the copper foil A so that the thickness of the resin would be 9.0 μm after curing. Then, the resultant was dried under heat at 70 to 130° C., whereby the solvent was removed. Next, a solution of the polyimide precursor resin K₂ prepared in Synthesis Example 24 was uniformly applied onto the resultant so that the thickness of the resin would be 2.0 μm after curing. Then, the resultant was dried under heat at 130° C., whereby the solvent was removed. After that, the resultant was imidated by a heat treatment at 130° C., 160° C., 200° C., 230° C., 280° C., 320° C., and 360° C. in stages for 2 to 30 minutes in each stage, whereby a CCL (M13) having an insulating resin layer composed of two polyimide resin layers and having a total thickness of 11 μm formed on the copper foil was obtained. The respective polyimide resin layers M₂ and K₂ on the copper foil had thicknesses of 9.0 μm and 2.0 μm, respectively. Table 13 shows the results of the evaluation of the CCL for characteristics.

TABLE 13

| | Example | Example | Comp. |
|---|---|---|---|
| | 39 | 40 | Example 13 |
| CCL | M11 | M12 | M13 |
| PI layer thickness μm | 12 | 13 | 11 |
| PI tear propagation resistance mN | 31 | 44 | 15 |
| CTE ppm/K | 25 | 23 | 10 |
| Tg ° C. | 360 | 360 | 391 |
| E′ (400° C.) GPa | 0.26 | 0.26 | 1.23 |
| Peel strength kN/m | 1.3 | 1.4 | 0.1 |
| MIT folding resistance times | 1069 | 748 | 807 |

### Example 41

A solution of the polyimide precursor resin A₂ prepared in Synthesis Example 14 was uniformly applied onto a stainless steel foil A (stainless steel foil having a thickness of 20 μm, SUS304 manufactured by NIPPON STEEL CORPORATION.) so that the thickness of the resin would be 10 μm after curing. Then, the resultant was dried under heat at 110° C., whereby the solvent was removed. After that, the resultant was imidated by a heat treatment at 130° C. to 360° C. in stages for 2 to 30 minutes in each stage, whereby a laminate having an insulating resin layer composed of polyimide resin layers having a thickness of 10 μm formed on the stainless steel foil was obtained. The physical properties shown in Table 14 of the laminate were measured.

### Example 42

A solution of the polyimide precursor resin A₂ prepared in Synthesis Example 14 was uniformly applied onto a stainless steel foil A so that the thickness of the resin would be 8.5 μm after curing. Then, the resultant was dried under heat at 110° C., whereby the solvent was removed. Further, a solution of the polyimide precursor resin V prepared in Synthesis Example 13 was uniformly applied onto the resultant so that the thickness of the resin would be 1.5 μm after curing. Then, the resultant was dried under heat at 110° C., whereby the solvent was removed. After that, the resultant was imidated by a heat treatment at 130° C. to 360° C. in stages for 2 to 30 minutes in each stage, whereby a laminate having an insulating resin layer composed of two polyimide resin layers and having a total thickness of 10 μm formed on the stainless steel foil was obtained. The physical properties shown in Table 14 of the laminate were measured.

### Example 43

A solution of the polyimide precursor resin U prepared in Synthesis Example 12 was uniformly applied onto a stainless steel foil A so that the thickness of the resin would be 1.0 μm after curing. Then, the resultant was dried under heat at 110° C., whereby the solvent was removed. Next, a solution of the polyimide precursor resin A₂ prepared in Synthesis Example 14 was uniformly applied onto the resultant so that the thickness of the resin would be 7.5 μm after curing. Then, the resultant was dried under heat at 110° C., whereby the solvent was removed. Further, a solution of the polyimide precursor resin V prepared in Synthesis Example 13 was uniformly applied onto the resultant so that the thickness of the resin would be 1.5 μm after curing. Then, the resultant was dried under-heat at 110° C., whereby the solvent was removed. After that, the resultant was imidated by a heat treatment at 130° C. to 360° C. in stages for 2 to 30 minutes in each stage, whereby a laminate having an insulating resin layer composed of three polyimide resin layers and having a total thickness of 10 μm formed on the stainless steel foil was obtained. The physical properties shown in Table 14 of the laminate were measured.

TABLE 14

| | | Example | Example | Example |
|---|---|---|---|---|
| | | 41 | 42 | 43 |
| PI layer thickness | μm | 10 | 10 | 10 |
| PI tear propagation | mN | 30 | 25 | 20 |
| resistance | | | | |
| CTE | ppm/K | 23 | 23 | 23 |
| 1 mm peel strength | kN/m | 1.2 | 1.2 | 1.5 |
| Moisture absorptivity | wt % | 1.0 | 1.0 | 1.0 |
| PI etching rate | μm/min | 20 | 20 | 20 |
| PI etching shape | | Good | Good | Good |

According to the present invention, a polyimide resin for an insulating layer of which a laminate for a wiring board is constituted has high heat resistance, is excellent in dimensional stability, and furthermore, is tough, so the thickness of a polyimide resin layer can be reduced, and hence a laminate for a flexible wiring board excellent in flexing resistance can be obtained. Therefore, the laminate can be suitably used in a COF application where the rupture or deformation of a sprocket hole or the like is of particular concern. In addition, the laminate for a wiring board of the present invention can be suitably used as a laminate for an HDD suspension as well because a polyimide resin layer for use in the laminate for a wiring board of the present invention has a good etching characteristic.

What is claimed is:

1. A laminate for a wiring board, comprising:
a polyimide resin layer composed of one or more layers; and
a metal layer on at least one surface of the polyimide resin layer,
wherein:
a polyimide resin layer (A) obtained by imidating a polyimide precursor resin having a weight average molecular weight in a range of 150,000 to 800,000 is a main polyimide resin layer; and
a polyimide resin of which the polyimide resin layer (A) is constituted is comprised of structural units represented by the following general formulae (1), (2), and (3): 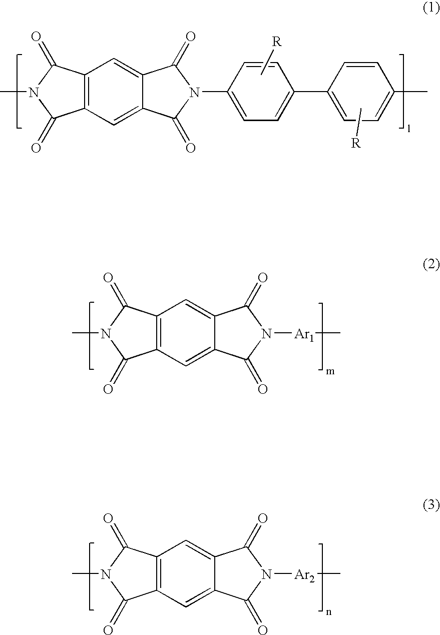
wherein, in the general formulae (1), R represents one of a lower alkyl group having 1 to 6 carbon atoms, a phenyl group, and a halogen atom, in the general formulae (2), Ar₁ represents a divalent aromatic group chosen from the following formulae (a) and (b), Ar₃ represents a divalent aromatic group chosen from the following formulae (c) and (d), in the general formulae (3), Ar₂ represents a residue of one of 3,4′-diaminodiphenylether and 4,4′-diaminodiphenylether, and 1, m, and n each represent an abundance molar ratio, and 1 represents a number in a range of 0.6 to 0.9, m represents a number in a range of 0.1 to 0.3, and n represents a number in a range of 0 to 0.2.

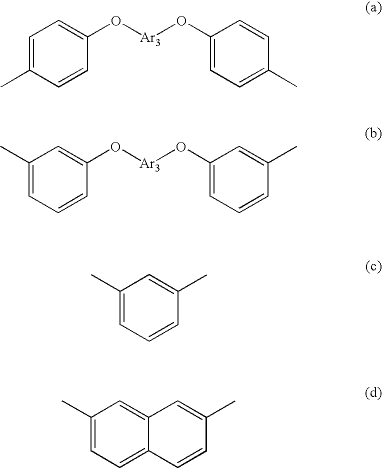

2. A laminate for a wiring board according to claim 1, wherein, in the general formulae (1), (2), and (3), 1 represents 0.7 to 0.9, m represents 0.1 to 0.3, and n represents 0.

3. A laminate for a wiring board according to claim 1, wherein, in the general formulae (1), (2), and (3), 1 represents 0.6 to 0.9, m represents 0.1 to 0.3, and n represents 0.01 to 0.2.

4. A laminate for a wiring board according to claim 1, wherein the polyimide resin layer (A) has a thickness in a range of 5 to 30 μm, a tear propagation resistance in a range of to 100 to 400 mN, and a coefficient of thermal expansion of 30×10⁻⁶/K or less.

5. A laminate for a wiring board according to claim 1, wherein the polyimide resin layer (A) has a glass transition temperature of 310° C. or higher, and an elastic modulus at 400° C. of 0.1 GPa or more.

6. A laminate for a wiring board according to claim 1, wherein the laminate for a wiring board comprises a laminate for a flexible wiring board.

7. A laminate for a wiring board according to claim 1, wherein the laminate for a wiring board comprises a laminate for an HDD suspension.

8. A flexible wiring board for chip on film, comprising a sprocket hole having a desired shape, the sprocket hole being provided for a side portion of the flexible wiring board obtained by subjecting the laminate for a wiring board according to claim 6 to wiring processing.
